(19) United States
(12) Patent Application Publication
(10) Pub. No.: US 2022/0216722 A1
(43) Pub. Date: Jul. 7, 2022

(54) CHARGING SYSTEM

(71) Applicant: HONDA MOTOR CO., LTD., Tokyo (JP)

(72) Inventor: Yasumichi Onuki, Wako-shi (JP)

(21) Appl. No.: 17/558,631

(22) Filed: Dec. 22, 2021

(30) Foreign Application Priority Data
Jan. 7, 2021 (JP) 2021-001663

(51) Int. Cl. H02J 7/02; H02J 7/00

(52) U.S. Cl. CPC H02J 7/02; H02J 7/00304; H02J 7/0013

(57) ABSTRACT

A charging system includes an AC power source, a plurality of circuit modules, and a control device. The plurality of circuit modules are connected between the AC power source and each of a plurality of battery modules. Each of the circuit modules supplies DC power obtained by rectifying AC power supplied from the AC power source to each of the battery modules. Each of the circuit modules includes two second capacitors in an A-phase electric line and a B-phase electric line, which disconnect a connection portion (for example, a wire) connecting the plurality of circuit modules from each of the battery modules in a direct current manner.

### CROSS-REFERENCE TO RELATED APPLICATION

Priority is claimed on Japanese Patent Application No. 2021-001663, filed Jan. 7, 2021, the content of which is incorporated herein by reference.

### BACKGROUND OF THE INVENTION

### Field of the Invention

The present invention relates to a charging system.

### Description of Related Art

Conventionally, for example, a power supply device for supplying electric power to a plurality of battery modules connected in series is known (refer to, for example, Japanese Unexamined Patent Application, First Publication No. 2011-67021). The power supply device includes a rectifier circuit connected to each of the plurality of battery modules, an alternating current (AC) electric line which sequentially connects a plurality of rectifier circuits to each other, and an AC generating circuit which applies an AC voltage to the AC electric line.

### SUMMARY OF THE INVENTION

In the above-described conventional power supply device, since the circuit module in which the rectifier circuit and the AC electric line are integrated for each of the plurality of battery modules is formed, a device constitution is simplified by the plurality of the same circuit modules, and an increase in the cost required for the constitution can be curbed. However, the wire which connects the plurality of circuit modules to each other becomes a live-wire portion to which a direct current (DC) voltage from each of the battery modules is applied, and for example, when biting by a metal part or the like occurs, a short circuit may occur.

An aspect according to the present invention has been made in consideration of such circumstances, and an object of the present invention is to provide a charging system capable of curbing occurrence of a short circuit while complexity of a device constitution is curbed.

In order to solve the above problems and to achieve the above object, the present invention has adopted the following aspects.

(1) A charging system according to one aspect of the present invention is a charging system which charges a plurality of power storage modules which form a power storage device, including an AC power source, a plurality of circuit modules connected between the AC power source and each of the plurality of power storage modules and configured to supply DC power obtained by rectifying AC power supplied from the AC power source to the plurality of power storage modules, at least one capacitor configured to disconnect a connection portion configured to connect the plurality of circuit modules from each of the plurality of power storage modules in a direct current manner.

(2) In the aspect (1), each of the plurality of circuit modules may include a rectifying part which rectifies the AC power, and an AC electric line which connects the AC power source to the rectifying part, and the at least one capacitor may be disposed in the AC electric line or the rectifying part.

(3) In the aspect (2), the plurality of circuit modules may be sequentially connected from the AC power source and may include a second capacitor disposed between the AC power source and the circuit module which is initially connected to the AC power source in addition to a first capacitor which is at least one capacitor disposed in the AC electric line.

According to the aspect (1), it is possible to curb the occurrence of a DC short circuit at the connection portion while maintaining the transmission of AC power by providing at least one capacitor which disconnects the connection portion connecting the plurality of circuit modules from each of the plurality of power storage modules in a direct current manner. Since the capacitor for DC interruption is provided in each of the plurality of circuit modules, a device constitution can be simplified due to the plurality of the same circuit modules corresponding to the plurality of power storage modules, and an increase in the cost required for the constitution can be curbed.

In the case of the aspect (2), since at least one capacitor disposed in the AC electric line or the rectifying part of each of the circuit modules is provided, it is possible to easily connect the plurality of circuit modules while they are disconnected in a direct current manner.

In the case of the aspect (3), since the second capacitor disposed between the AC power source and the circuit module which is initially connected to the AC power source is provided, a current gain of a resonant electric line corresponding to each of the plurality of power storage modules can be made uniform by the plurality of the same circuit modules. Thus, a system constitution is simplified, and it is possible to supply power evenly to each of the plurality of power storage modules while an increase in the cost required for the constitution is curbed.

### BRIEF DESCRIPTION OF THE DRAWINGS

FIG. 1 is a diagram showing a constitution of a charging system according to an embodiment of the present invention.

FIG. 2 is a perspective view showing a constitution of a plurality of circuit modules and battery modules of the charging system according to the embodiment of the present invention.

FIG. 3 is a diagram showing a constitution of an AC power source of the charging system according to the embodiment of the present invention.

FIG. 4 is a diagram showing a constitution of a rectifier circuit of the charging system according to the embodiment of the present invention.

FIG. 5 is a diagram showing a constitution of a charging system according to a first modified example of the embodiment of the present invention.

FIG. 6 is a diagram showing a constitution of a charging system according to a second modified example of the embodiment of the present invention.

FIG. 7 is a diagram showing a constitution of a rectifier circuit of the charging system according to the second modified example of the embodiment of the present invention.

FIG. 8 is a diagram showing a circuit example related to the charging system according to the second modified example of the embodiment of the present invention.

FIG. 9 is a diagram showing an example of frequency response characteristics of a first embodiment and a second embodiment and a comparative example in the circuit example shown in FIG. 8.

FIG. 10 is a diagram showing a constitution of a rectifier circuit of a charging system according to a third modified example of the embodiment of the present invention.

### DETAILED DESCRIPTION OF THE INVENTION

Hereinafter, a charging system 10 according to an embodiment of the present invention will be described with reference to the accompanying drawings.

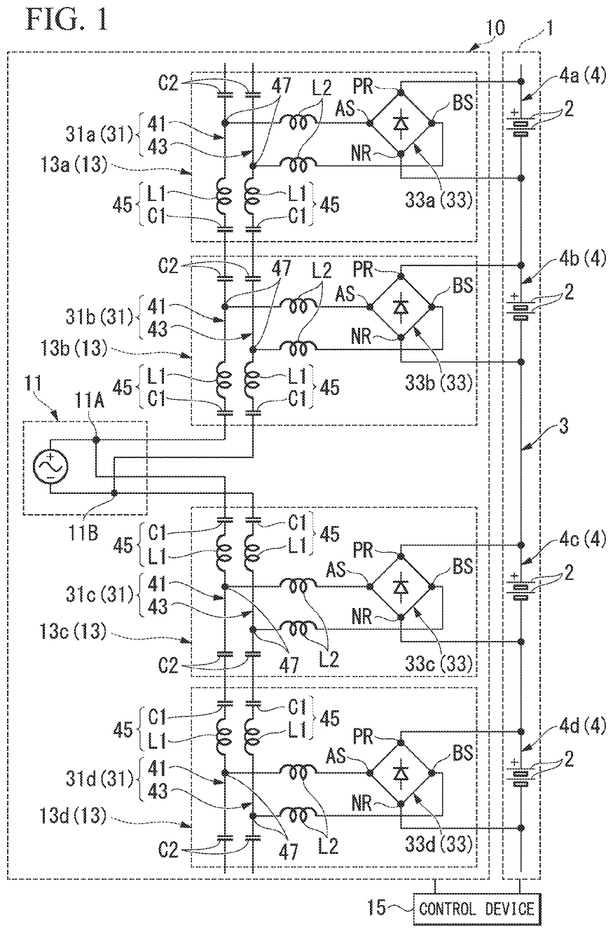

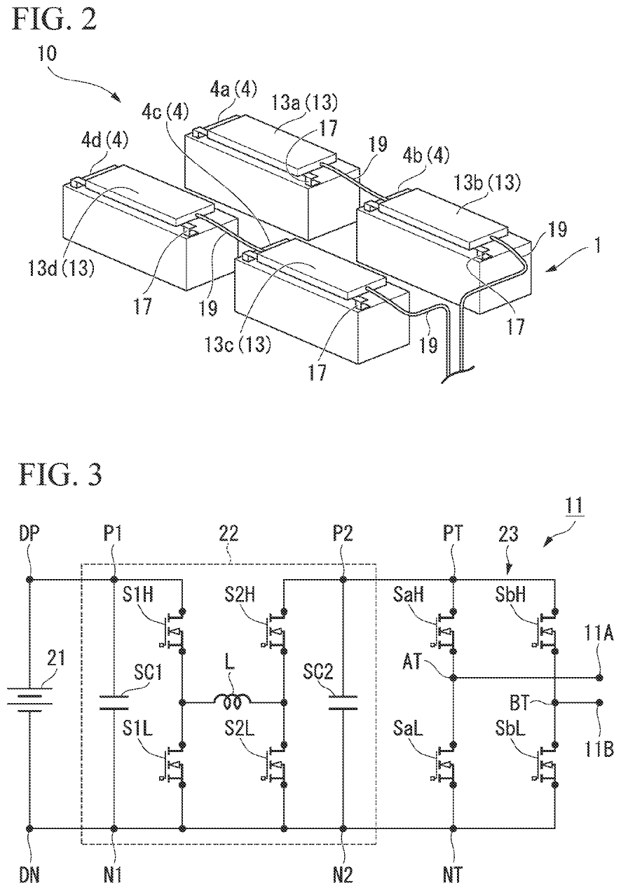

FIG. 1 is a diagram showing a constitution of the charging system 10 according to the embodiment. FIG. 2 is a perspective view showing a constitution of a plurality of circuit modules 13 and battery modules 4 of the charging system 10 in the embodiment.

The charging system 10 according to the present embodiment is mounted in a vehicle such as an electrified vehicle. The charging system 10 is connected to a power storage device mounted in the vehicle. The electrified vehicle is an electric vehicle, a hybrid vehicle, a fuel cell vehicle, or the like. The electric vehicle is driven by a power storage device as a power source. The hybrid vehicle is driven by a power storage device and an internal combustion engine as a power source. A fuel cell vehicle is driven by a fuel cell as a power source.

As shown in FIGS. 1 and 2, the power storage device connected to the charging system 10 is, for example, a high-voltage battery 1 which is a power source for a vehicle. The battery 1 includes, for example, a string 3 formed by a plurality of cells 2 connected in series, and a positive electrode terminal and a negative electrode terminal at both ends of the string 3. The battery 1 includes a plurality of battery modules 4 formed by dividing the string 3 into a plurality of substrings in series. The plurality of battery modules 4 are, for example, a first battery module 4a, a second battery module 4b, a third battery module 4c, and a fourth battery module 4d formed by dividing the string 3 into four parts. For example, the first battery module 4a, the second battery module 4b, the third battery module 4c, and the fourth battery module 4d are sequentially connected in series.

The charging system 10 includes an AC power source 11, a plurality of circuit modules 13, and a control device 15.

FIG. 3 is a diagram showing a constitution of the AC power source 11 of the charging system 10 according to the embodiment.

As shown in FIG. 3, the AC power source 11 includes a DC power source 21, a first power conversion part 22, and a second power conversion part 23.

The DC power source 21 is, for example, a solar cell or the like.

The first power conversion part 22 includes, for example, a DC-DC converter which performs two types of power conversions including stepping-up and stepping-down. The first power conversion part 22 includes a first positive electrode terminal P1 and a first negative electrode terminal N1, and a second positive electrode terminal P2 and a second negative electrode terminal N2.

The first positive electrode terminal P1 and the first negative electrode terminal N1 of the first power conversion part 22 are connected to a positive electrode terminal DP and a negative electrode terminal DN of the DC power source 21. The second positive electrode terminal P2 and the second negative electrode terminal N2 of the first power conversion part 22 are connected to a positive electrode terminal PT and a negative electrode terminal NT of the second power conversion part 23.

The first power conversion part 22 includes, for example, switching elements of a low side arm and a high side arm paired in two phases, and a reactor. Each of the switching elements is a transistor such as a metal oxide semi-conductor field effect transistor (MOSFET) or an insulated gate bipolar transistor (IGBT) and is, for example, an N-channel type MOSFET. The reactor is a choke coil L.

Each of the transistors may include a rectifying element. The rectifying element is a diode connected in parallel to each of the transistors. The rectifying element is, for example, a freewheeling diode connected in a forward direction from a source to a drain between the drain and the source of the MOSFET.

The first power conversion part 22 includes first-phase transistors S1H and S1L of the high side arm and the low side arm paired in the first phase, and second-phase transistors S2H and S2L of the high side arm and the low side arm paired in the second phase.

A drain of the first-phase transistor S1H of the high side arm is connected to the first positive electrode terminal P1. A drain of the second-phase transistor S2H of the high side arm is connected to the second positive electrode terminal P2. A source of the first-phase transistor S1L of the low side arm is connected to the first negative electrode terminal N1. A source of the second-phase transistor S2L of the low side arm is connected to the second negative electrode terminal N2. The source of the first-phase transistor S1H of the high side arm and the drain of the first-phase transistor SlL of the low side arm are connected to a first end of the two ends of the choke coil L. The source of the second-phase transistor S2H of the high side arm and the drain of the second-phase transistor S2L of the low side arm are connected to a second end of the two ends of the choke coil L.

The first power conversion part 22 includes a first smoothing capacitor (a capacitor) SC1 connected between the first positive electrode terminal P1 and the first negative electrode terminal N1, and a second smoothing capacitor (a capacitor) SC2 connected between the second positive electrode terminal P2 and the second negative electrode terminal N2. The first smoothing capacitor SC1 and the second smoothing capacitor SC2 smooth voltage fluctuations which are generated along with an on/off switching operation of each of the transistors S1H, S1L, S2H, and S2L.

The first power conversion part 22 switches between ON (connection) and OFF (disconnection) of each of the transistors S1H, S1L, S2H, and S2L based on a gate signal which is a switching command input to a gate of each of the transistors S1H, S1L, S2H, and S2L.

At the time of stepping-up, the first power conversion part 22 steps up power input from the DC power source 21 to the first positive electrode terminal P1 and the first negative electrode terminal N1 and outputs the stepped-up power from the second positive electrode terminal P2 and the second negative electrode terminal N2. The first power conversion part 22 keeps the first-phase transistor S1H of the high side arm ON (connected) and the first-phase transistor SlL of the low side arm OFF (disconnected) at the time of stepping-up.

The first power conversion part 22 stores magnetic energy by direct current excitation of the reactor (the choke coil L) during the second-phase transistor S2H of the high side arm being OFF (disconnected) and the second-phase transistor S2L of the low side arm being ON (connected). The first power conversion part 22 generates a voltage higher than that of the first positive electrode terminal P1 and the first negative electrode terminal N1 at the second positive electrode terminal P2 and the second negative electrode terminal N2 by superimposing an induced voltage generated by magnetic energy of the reactor (the choke coil L) during the second-phase transistor S2H of the high side arm being ON (connected) and the second-phase transistor S2L of the low side arm being OFF (disconnected) on a voltage applied to the first positive electrode terminal P1 and the first negative electrode terminal N1.

At the time of stepping-down, the first power conversion part 22 steps down power input from the first positive electrode terminal P1 and the first negative electrode terminal N1 and outputs the stepped-up power from the second positive electrode terminal P2 and the second negative electrode terminal N2. The first power conversion part 22 keeps the second-phase transistor S2H of the high side arm ON (connected) and the second-phase transistor S2L of the low side arm OFF (disconnected) at the time of stepping-down.

The first power conversion part 22 stores magnetic energy by direct current excitation of the reactor (the choke coil L) upon the ON (connection) of the first-phase transistor S1H of the high side arm and the OFF (disconnection) of the first-phase transistor S1L of the low side arm. The first power conversion part 22 generates a voltage lower than that of the first positive electrode terminal P1 and the first negative electrode terminal N1 at the second positive electrode terminal P2 and the second negative electrode terminal N2 by stepping down the induced voltage generated by the magnetic energy of the reactor (the choke coil L) upon the OFF (disconnection) of the first-phase transistor S1H of the high side arm and the ON (connection) of the first-phase transistor SlL of the low side arm.

The second power conversion part 23 includes, for example, an inverter which converts the DC power input from the first power conversion part 22 into AC power and outputs the AC power to the AC electric line 12.

The second power conversion part 23 includes, for example, a bridge circuit formed by a plurality of switching elements bridge-connected in two phases including an A-phase and a B-phase. The switching element is a transistor such as a MOSFET or an IGBT, and is, for example, an N-channel type MOSFET. Each of the transistors may include a rectifying element. The rectifying element is a diode connected in parallel to each of the transistors. The rectifying element is, for example, a freewheeling diode connected in the forward direction from a source to a drain between the drain and the source of the MOSFET.

The second power conversion part 23 includes A-phase transistors SaH and SaL of the high side arm and the low side arm paired in the A-phase, and B-phase transistors SbH and SbL of the high side arm and the low side arm paired in the B-phase.

Each of drains of the A-phase transistor SaH of the high side arm and the B-phase transistor SbH of the high side arm is connected to the positive electrode terminal PT. Each of sources of the A-phase transistor SaL of the low side arm and the B-phase transistor SbL of the low side arm is connected to the negative electrode terminal NT. A source of the A-phase transistor SaH of the high side arm and a drain of the A-phase transistor SaL of the low side arm are connected to an A-phase terminal AT. The source of the B-phase transistor SbH of the high side arm and the drain of the B-phase transistor SbL of the low side arm are connected to a B-phase terminal BT.

The second power conversion part 23 switches between ON (connection) and OFF (disconnection) of the transistor pair of each phase based on a gate signal which is a switching command input to a gate of each of the transistors SaH, SaL, SbH, and SbL. The second power conversion part 23 converts the DC power input from the positive electrode terminal PT and the negative electrode terminal NT into single-phase AC power and outputs the single-phase AC power from the A-phase terminal AT and the B-phase terminal BT. The A-phase terminal AT of the second power conversion part 23 is connected to an A-phase terminal 11A of the AC power source 11, and the B-phase terminal BT of the second power conversion part 23 is connected to a B-phase terminal 11B of the AC power source 11.

For example, the AC power source 11 supplies the same current (power) to each of the battery modules 4 of the battery 1 when generating an alternating current having a frequency close to a resonance frequency of an AC electric line 31 (a resonant electric line) which will be described below.

As shown in FIGS. 1 and 2, the plurality of circuit modules 13 are connected between the AC power source 11 and each of the plurality of battery modules 4. The number of the plurality of circuit modules 13 is the same as the number of the plurality of battery modules 4. The plurality of circuit modules 13 are, for example, a first circuit module 13a, a second circuit module 13b, a third circuit module 13c, and a fourth circuit module 13d.

As shown in FIG. 2, the first battery module 4a and the first circuit module 13a are integrally connected to each other, the second battery module 4b and the second circuit module 13b are integrally connected to each other, the third battery module 4c and the third circuit module 13c are integrally connected to each other, and the fourth battery module 4d and the fourth circuit module 13d are integrally connected to each other. Each of the battery modules 4 and each of the circuit modules 13 are connected by, for example, a bus bar 17 having an insulating coating. The plurality of circuit modules 13 are sequentially connected by wires 19 from the AC power source 11. For example, the second circuit module 13b and the first circuit module 13a are sequentially connected from the AC power source 11, and the third circuit module 13c and the fourth circuit module 13d are sequentially connected from the AC power source 11.

As shown in FIG. 1, each of the plurality of circuit modules 13 includes the AC electric line 31 and a rectifier circuit 33. For example, the first circuit module 13a includes a first AC electric line 31a and a first rectifier circuit 33a. The second circuit module 13b includes a second AC electric line 31b and a second rectifier circuit 33b. The third circuit module 13c includes a third AC electric line 31c and a third rectifier circuit 33c. The fourth circuit module 13d includes a fourth AC electric line 31d and a fourth rectifier circuit 33d.

Each of the AC electric line 31 includes an A-phase electric line 41 directly or indirectly connected to an A-phase terminal 11A of the AC power source 11 and a B-phase electric line 43 directly or indirectly connected to a B-phase terminal 11B of the AC power source 11. Each of the A-phase electric line 41 and the B-phase electric line 43 includes a LC row 45 of the first capacitor (the capacitor) C1 and the first reactor L1 connected to each other in series on the input side of the AC power, a second capacitor (a capacitor) C2, and a second reactor L2.

The second capacitor C2 and the second reactor L2 branch at a connection point 47 provided via the LC row 45 from the input side of the AC power in the AC electric line 31 and are connected to the LC row 45. The second capacitor C2 is connected between the connection point 47 and the LC row 45 of the adjacent circuit module 13.

For example, the second capacitor C2 of the second circuit module 13b is connected between the connection point 47 of the second circuit module 13b and the LC row 45 of the adjacent first circuit module 13a.

For example, the second capacitor C2 of the third circuit module 13c is connected between the connection point 47 of the third circuit module 13c and the LC row 45 of the adjacent fourth circuit module 13d.

The second capacitor C2 may be omitted in the circuit module 13 (for example, each of the first circuit module 13a and the fourth circuit module 13d, or the like) disposed at the terminal among the plurality of circuit modules 13.

The second capacitor C2 disconnects the connection portion (for example, a portion of the wire 19) which connects the adjacent circuit modules 13 from each of the plurality of battery modules 4 in a direct current manner.

For example, the second capacitor C2 of the second circuit module 13b disconnects the connection portion (for example, a portion of the wire 19) between the AC electric line 31a of the first circuit module 13a and the AC electric line 3 lb of the second circuit module 13b from each of the plurality of battery modules 4 in a direct current manner.

For example, the second capacitor C2 of the third circuit module 13c disconnects the connection portion (for example, a portion of the wire 19) between the AC electric line 31c of the third circuit module 13c and the AC electric line 31d of the fourth circuit module 13d from each of the plurality of battery modules 4 in a direct current manner. The second reactor L2 is connected between the connection point 47 and the rectifier circuit 33.

A combination of a combined capacitance of the capacitors of the AC electric line 31 and a combined inductance of the inductors (for example, the product of the combined capacitance and the combined inductance) in each of the plurality of circuit modules 13 may be an appropriate combination. For example, when the product (the LC product) of the combined capacitance and the combined inductance of the resonant electric line for each stage corresponding to each of the battery modules 4 of the battery 1 is the same, a current gain for each of the battery modules 4 is the same, and the same current (power) is uniformly supplied to each of the battery modules 4.

For example, when a first LC product with respect to the first battery module 4a, a second LC product with respect to the second battery module 4b, a third LC product with respect to the third battery module 4c and a fourth LC product with respect to the fourth battery module 4d are the same as each other, the same current (power) is uniformly supplied to each of the battery modules 4a, 4b, 4c, and 4d. For example, each of the LC products is the product of the combined capacitance and the combined inductance of the capacitors and the reactors other than the second reactor L2 in each of the electric lines from the AC power source 11 to each of the rectifier circuits 33.

The first LC product is the product of the combined capacitance and the combined inductance of the first capacitor C1 and the first reactor L1 of the first circuit module 13a indirectly connected to the AC power source 11 via the second circuit module 13b, and the first capacitor C1, the first reactor L1 and the second capacitor C2 of the second circuit module 13b.

The second LC product is the product of the combined capacitance and the combined inductance of the first capacitor C1 and the first reactor L1 of the second circuit module 13b directly connected to the AC power source 11.

The third LC product is the product of the combined capacitance and the combined inductance of the first capacitor C1 and the first reactor L1 of the third circuit module 13c directly connected to the AC power source 11.

The fourth LC product is the product of the combined capacitance and the combined inductance of the first capacitor C1 and the first reactor L1 of the fourth circuit module 13d indirectly connected to the AC power source 11 via the third circuit module 13c, and the first capacitor C1, the first reactor L1 and the second capacitor C2 of the third circuit module 13c.

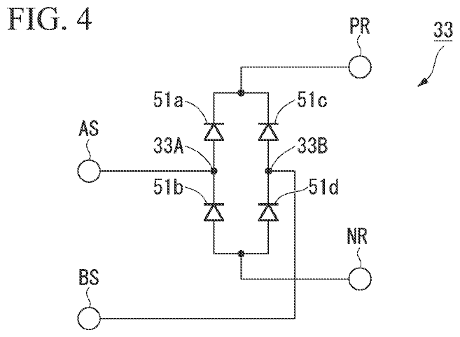

FIG. 4 is a diagram showing a constitution of the rectifier circuit 33 of the charging system 10 according to the embodiment.

In each of the plurality of circuit modules 13, the connection point 47 of the A-phase electric line 41 of the AC electric line 31 is connected to an A-phase terminal AS of the rectifier circuit 33 via the second reactor L2. The connection point 47 of the B-phase electric line 43 of the AC electric line 31 is connected to a B-phase terminal BS of the rectifier circuit 33 via the second reactor L2.

As shown in FIG. 4, the rectifier circuit 33 includes, for example, a bridge circuit formed by a plurality of diodes bridge-connected in a first row and a second row.

The rectifier circuit 33 is, for example, a full-wave rectifier circuit. The rectifier circuit 33 includes a first diode 51a and a second diode 51b connected in the forward direction in the first row, and a third diode 51c and a fourth diode 51d connected in the forward direction in the second row.

A connection point 33A between an anode of the first diode 51a and a cathode of the second diode 51b is connected to the A-phase terminal AS. A connection point 33B between an anode of the third diode 51c and a cathode of the fourth diode 51d is connected to the B-phase terminal BS.

A cathode of each of the first diode 51a and the third diode 51c is connected to a positive electrode terminal PR. An anode of each of the second diode 51b and the fourth diode 51d is connected to a negative electrode terminal NR. The positive electrode terminal PR and the negative electrode terminal NR of the rectifier circuit 42 are connected to the positive electrode terminal and the negative electrode terminal of the corresponding battery module 4 in the battery 1.

The rectifier circuit 33 full-wave rectifies the AC power input from the A-phase terminal AS and the B-phase terminal BS and outputs rectified DC power from the positive electrode terminal PR and the negative electrode terminal NR.

As shown in FIG. 1, the control device 15 controls an operation of the charging system 10. For example, the control device 15 is a software function part which functions by executing a predetermined program in a processor such as a central processing unit (CPU). The software function part is an electronic control unit (ECU) including a processor such as a CPU, a read only memory (ROM) which stores a program, a random access memory (RAM) which temporarily stores data, and an electronic circuit such as a timer. At least a part of the control device 15 may be an integrated circuit such as a large scale integration (LSI).

For example, the control device 15 sets a timing for driving ON (connection) and OFF (disconnection) of each of the switching elements of the AC power source 11 and actually generates a gate signal for driving the ON (connection) and OFF (disconnection) of each of the switching elements.

As described above, the charging system 10 of the embodiment can curb occurrence of a DC short circuit at a connection portion (for example, a portion of the wire 19) which connects the adjacent circuit modules 13 to each other, while the transmission of the AC power is maintained, by providing the second capacitor C2 for DC interruption disposed in each of the A-phase electric line 41 and the B-phase electric line 43 of each of the circuit modules 13. Thus, the adjacent circuit modules 13 can be easily connected to each other, the system constitution can be simplified, and an increase in the cost required for the constitution can be curbed.

It is possible to supply power evenly to each of the battery modules 4 by making the product of the combined capacitance and the combined inductance (the LC product) uniform so that a current gain of the resonant electric line corresponding to each of the battery modules 4 is the same.

### MODIFIED EXAMPLES

Hereinafter, modified examples of the embodiment will be described. The same parts as those in the above-described embodiment are designated by the same reference numerals, and description thereof will be omitted or simplified.

### First Modified Example

In the above-described embodiment, a capacitor for gain adjustment may be provided between the circuit module 13 directly connected to the AC power source 11 and the AC power source 11.

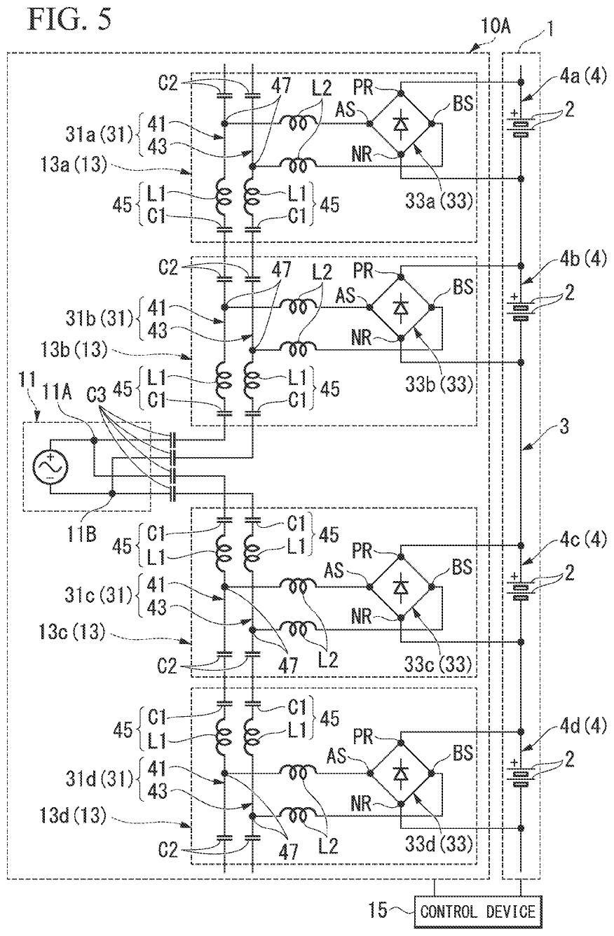

FIG. 5 is a diagram showing a constitution of a charging system 10A in a first modified example of the embodiment.

As shown in FIG. 5, the charging system 10A in the first modified example includes a plurality of third capacitors (capacitors) C3 between each of the second circuit module 13b and the third circuit module 13c directly connected to the AC power source 11 and the AC power source 11.

For example, the plurality of third capacitors C3 are four third capacitors C3 disposed in the A-phase electric line 41 and the B-phase electric line 43 of each of the second circuit module 13b and the third circuit module 13c which is initially connected to the AC power source 11 among the plurality of circuit modules 13 which are sequentially connected from the AC power source 11.

According to the first modified example, due to the third capacitor C3 for gain adjustment provided between each of the second circuit module 13b and the third circuit module 13c directly connected to the AC power source 11 and the AC power source 11, the current gain of the resonant electric line corresponding to each of the battery modules 4 can be made the same by the plurality of the same circuit modules 13. Thus, the system constitution can be simplified, and power can be evenly supplied to each of the plurality of battery modules 4 while an increase in the cost required for the constitution is curbed.

### Second Modified Example

In the above-described embodiment, each of the plurality of circuit modules 13 includes the second capacitor C2 for DC interruption in the AC electric line 31, but the present invention is not limited thereto.

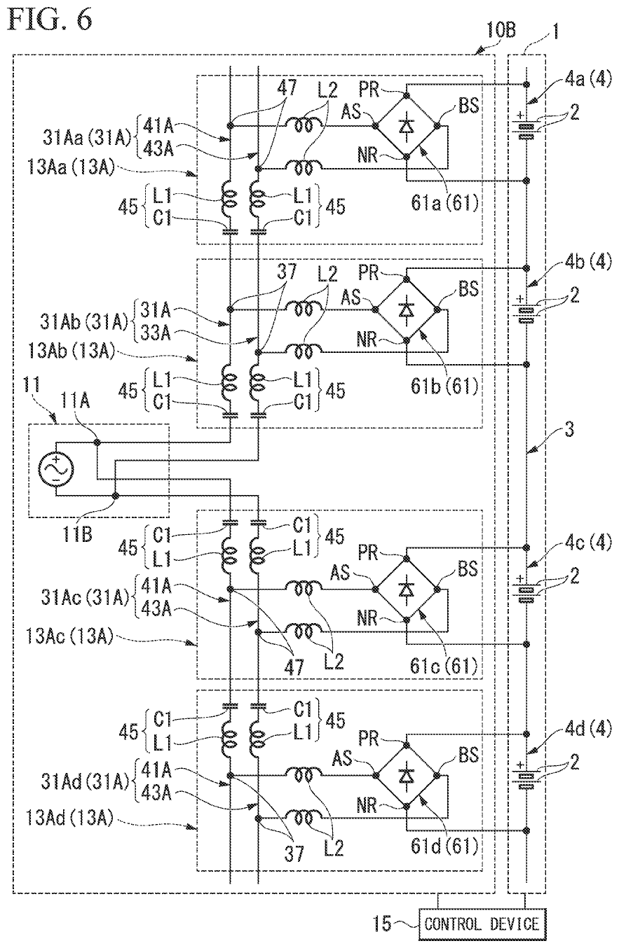

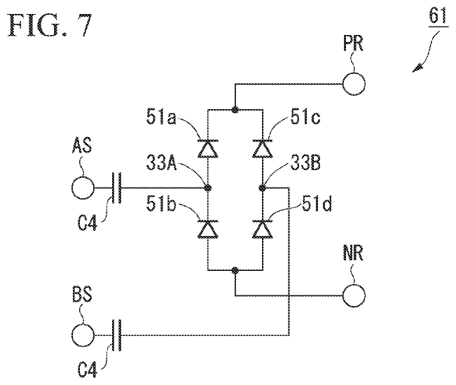

FIG. 6 is a diagram showing a constitution of a charging system 10B in a second modified example of the embodiment. FIG. 7 is a diagram showing a constitution of a rectifier circuit of the charging system 10B in the second modified example of the embodiment.

As shown in FIG. 6, the charging system 10B of the second modified example includes an AC power source 11, a plurality of circuit modules 13A, and a control device 15. The plurality of circuit modules 13A are connected between the AC power source 11 and each of the plurality of battery modules 4. The number of the plurality of circuit modules 13A is the same as the number of the plurality of battery modules 4. The plurality of circuit modules 13A are, for example, a first circuit module 13Aa, a second circuit module 13Ab, a third circuit module 13Ac, and a fourth circuit module 13Ad.

Each of the plurality of circuit modules 13A includes an AC electric line 31A and a rectifier circuit 61. For example, the first circuit module 13Aa includes a first AC electric line 31Aa and a first rectifier circuit 61a. The second circuit module 13Ab includes a second AC electric line 31 Ab and a second rectifier circuit 61b. The third circuit module 13Ac includes a third AC electric line 31Ac and a third rectifier circuit 61c. The fourth circuit module 13Ad includes a fourth AC electric line 31Ad and a fourth rectifier circuit 61d.

An A-phase electric line 41A and a B-phase electric line 43A of the AC electric line 31A have a constitution in which the second capacitor C2 is omitted in the A-phase electric line 41 and the B-phase electric line 43 of the AC electric line 31 of the above-described embodiment.

As shown in FIG. 7, the rectifier circuit 61 of the second modified example includes the rectifier circuit 33 of the above-described embodiment and two fourth capacitors (capacitors) C4. The two fourth capacitors C4 are connected between the two connection points 33A and 33B and the A-phase terminal AS and the B-phase terminal BS. The two fourth capacitors C4 disconnects the connection portion (for example, a portion of the wire 19) connecting the adjacent circuit modules 13A from each of the plurality of battery modules 4 in a direct current manner.

According to the second modified example, the plurality of the same circuit modules 13A can be easily connected to each other while they are disconnected in a direct current manner. The current gain of the resonant electric line corresponding to each of the battery modules 4 can be easily made the same, and the power can be evenly supplied to each of the battery modules 4.

When gain characteristic changes due to the provision of the two fourth capacitors C4, it may be adjusted by changing other circuit components.

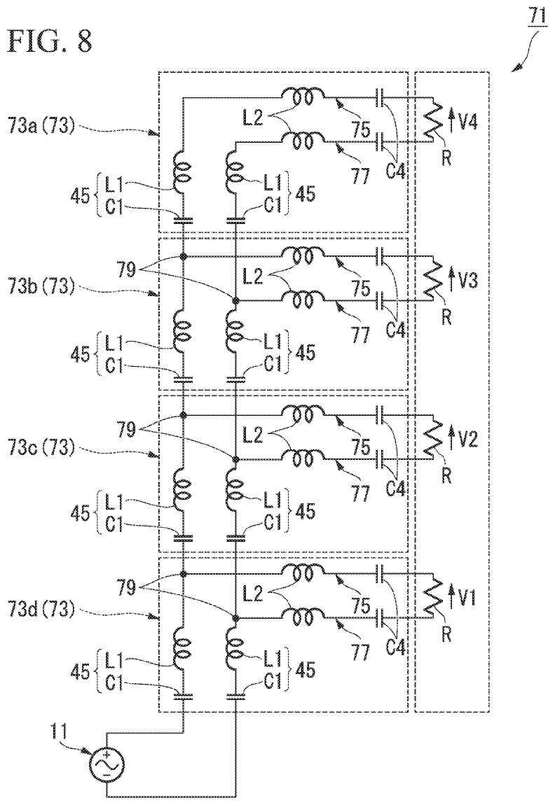

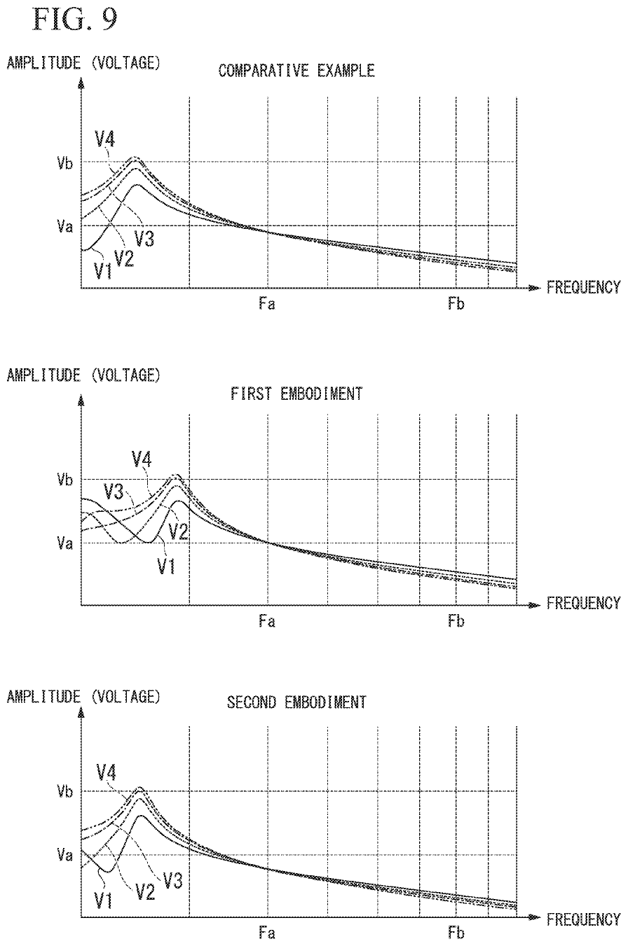

Hereinafter, frequency response characteristics in a circuit example related to the charging system 10B of the second modified example will be described. FIG. 8 is a diagram showing a circuit example 71 related to the charging system 10B in the second modified example of the embodiment. FIG. 9 is a diagram showing an example of the frequency response characteristics of the first embodiment and the second embodiment and a comparative example in the circuit example 71 shown in FIG. 8.

As shown in FIG. 8, the circuit example 71 in the first embodiment and the second embodiment includes a plurality of circuit modules 73 connected to a plurality of loads R, and the AC power source 11. The plurality of loads R are, for example, four loads R having the same load resistance. The plurality of circuit modules 73 are sequentially connected from the AC power source 11. The plurality of circuit modules 73 are, for example, a first circuit module 73a, a second circuit module 73b, a third circuit module 73c, and a fourth circuit module 73d connected between the AC power source 11 and each of the loads R.

Each of the plurality of circuit modules 73 includes a LC row 45 of a first capacitor (capacitor) C1 and a first reactor L1 connected in series on the input side of the AC power, a second reactor L2, and a fourth capacitor (capacitor) C4 in each of the A-phase electric line 75 and the B-phase electric line 77 connected to the AC power source 11. The second reactor L2 and the fourth capacitor C4 branch at a connection point 79 provided via the LC row 45 from the AC power input side in each of the A-phase electric line 75 and the B-phase electric line 77 and are connected to the LC row 45. In the terminal circuit module 73 (for example, the first circuit module 73a) among the plurality of circuit modules 73, the second reactor L2 and the fourth capacitor C4 are simply connected to the LC row 45 at each of the A-phase electric line 75 and the B-phase electric line 77 (that is, without the connection point 79 for branching).

The comparative example includes a constitution in which the fourth capacitor C4 is omitted in the circuit example 71 in each of the first embodiment and the second embodiment.

In the first embodiment and the comparative example, a combination of the capacitance of the first capacitor C1 and the inductance of each of the first reactor L1 and the second reactor L2 is the same.

In the first embodiment and the second embodiment, a combination of the capacitance of each of the first capacitor C1 and the fourth capacitor C4 and the inductance of the first reactor L1 is the same. The inductance of the second reactor L2 of the second embodiment is larger than the inductance of the second reactor L2 of the first embodiment.

As shown in FIG. 9, in the first embodiment and the comparative example in which only the presence or absence of the fourth capacitor C4 is different, a frequency at which the gains of the plurality of loads R match are the same predetermined frequency Fa. In the first embodiment, the gain at the predetermined frequency Fa is increased by providing the fourth capacitor C4 as compared with the comparative example. That is, in the first embodiment, an amplitude (a voltage) V1, V2, V3, V4 of each of the loads R at a predetermined frequency Fa is a predetermined amplitude Va, but in the comparative example, the amplitude (the voltage) V1, V2, V3, V4 of each of the loads R at the predetermined frequency Fa is smaller than the predetermined amplitude Va.

In the second embodiment, since the inductance of the second reactor L2 is set to be larger than that of the first embodiment, the gain is curbed, and the frequency response characteristics substantially equivalent to those of the comparative example not including the fourth capacitor C4 can be obtained.

### Third Modified Example

In the above-described embodiment and the second modified example, each of the plurality of circuit modules 13 includes the rectifier circuits 33 and 61 which are full-wave rectifier circuits, but the present invention is not limited thereto and may include other rectifier circuits.

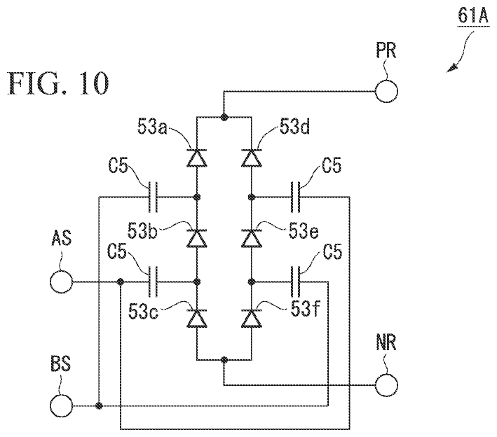

FIG. 10 is a diagram showing a constitution of a rectifier circuit 61A in a third modified example of the embodiment.

The rectifier circuit 61A of the third modified example is provided in place of the rectifier circuit 61 in the charging system 10B of the second modified example described above.

As shown in FIG. 10, the rectifier circuit 61A of the third modified example is, for example, a voltage doubler rectifier circuit. The rectifier circuit 61A includes a first diode 53a, a second diode 53b, and a third diode 53c which are connected in the forward direction in the first row, and a fourth diode 53d, a fifth diode 53e, and a sixth diode 53f which are connected in the forward direction in the second row, and four fifth capacitors (capacitors) C5.

An anode of the first diode 53a and a cathode of the second diode 53b, and an anode of the fifth diode 53e and a cathode of the sixth diode 53f are connected to the B-phase terminal BS via the fifth capacitors C5.

An anode of the second diode 53b and a cathode of the third diode 53c, and an anode of the fourth diode 53d and a cathode of the fifth diode 53e are connected to the A-phase terminal AS via the fifth capacitor C5.

The cathodes of the first diode 53a and the fourth diode 53d are connected to the positive electrode terminal PR. The anodes of the third diode 53c and the sixth diode 53f are connected to the negative electrode terminal NR. The positive electrode terminal PR and the negative electrode terminal NR of the rectifier circuit 61A are connected to the positive electrode terminal and the negative electrode terminal of the corresponding module 4 in the battery 1.

The rectifier circuit 61A rectifies the AC power input from the A-phase terminal AS and the B-phase terminal BS, steps up a voltage amplitude of the rectified DC power to twice the voltage amplitude of the AC power, and outputs the voltage from the positive electrode terminal PR and the negative electrode terminal NR.

The four fifth capacitors C5 disconnect the connection portion (for example, a portion of the wire 19) connecting the adjacent circuit modules 13A from each of the plurality of battery modules 4 in a direct current manner.

According to the third modified example, it is possible to easily connect a plurality of circuit modules 13A while they are disconnected in a direct current manner, and it is possible to improve versatility of the system.

In the above-described embodiment, the first power conversion part 22 performs two power conversions including stepping-up and stepping-down, but the present invention is not limited thereto, and a step-up circuit or a step-down circuit may be provided.

In the above-described embodiment, the charging system 10 is mounted in the vehicle, but the charging system 10 is not limited thereto and may be mounted in other devices.

In the above-described embodiment, the charging system 10 is connected to the power storage device, but the present invention is not limited thereto, and the charging system 10 may be connected to another load to supply power.

The embodiments of the present invention are presented as examples and are not intended to limit the scope of the invention. The embodiments can be implemented in various other types, and various omissions, replacements, and changes can be made without departing from the gist of the invention. The embodiments and variations thereof are included in the scope of the invention described in the claims and the equivalent scope thereof, as are included in the scope and gist of the invention.

What is claimed is:

1. A charging system which charges a plurality of power storage modules which form a power storage device, comprising:
an AC power source;
a plurality of circuit modules connected between the AC power source and each of the plurality of power storage modules and configured to supply DC power obtained by rectifying AC power supplied from the AC power source to the plurality of power storage modules; and
at least one capacitor configured to disconnect a connection portion configured to connect the plurality of circuit modules from each of the plurality of power storage modules in a direct current manner.

2. The charging system according to claim 1, wherein each of the plurality of circuit modules includes a rectifying part which rectifies the AC power, and an AC electric line which connects the AC power source to the rectifying part, and
the at least one capacitor is disposed in the AC electric line or the rectifying part.

3. The charging system according to claim 2, wherein the plurality of circuit modules are sequentially connected from the AC power source and include a second capacitor disposed between the AC power source and the circuit module which is initially connected to the AC power source in addition to a first capacitor which is at least one capacitor disposed in the AC electric line.
